(19) United States
(12) Patent Application Publication
(10) Pub. No.: US 2016/0016190 A1
(43) Pub. Date: Jan. 21, 2016

(54) Shower Head Cleaner Application Container

(71) Applicant: Jason Ryan Buswell, Ballston Lake, NY (US)

(72) Inventor: Jason Ryan Buswell, Ballston Lake, NY (US)

(21) Appl. No.: 14/332,321

(22) Filed: Jul. 15, 2014

(51) Int. Cl. B05B 15/02; B08B 3/04; B65D 1/40; B05B 1/18; B65D 25/22

(52) U.S. Cl. CPC B05B 15/025; B05B 1/18; B65D 25/22; B65D 1/40; B08B 3/04

(57) ABSTRACT

A device to contain liquid cleaner and attach to a shower head and shower arm so as to submerge the shower head and shower nozzle in the liquid cleaner to allow it to soak in the cleaner without having to first remove the shower head.

### CROSS-REFERENCE TO RELATED APPLICATIONS

Not Applicable.

### STATEMENT REGARDING FEDERALLY SPONSORED RESEARCH OR DEVELOPMENT

Not Applicable.

### SEQUENCE LISTING

Not Applicable.

### FIELD

The present invention relates to the field of cleaning. More particularly, the invention relates to applying liquid cleaner to a shower head.

### BACKGROUND OF THE INVENTION

Accumulation of minerals in the shower head can over time cause water flow to slow or stop. To bring a shower head back to full performance after it has become clogged requires removing the minerals that have built up. Spraying the shower head nozzle with a cleaner on the surface of the shower head and even scrubbing using bristle brush is often not fully effective especially for deeply embedded mineral buildup. However, soaking the shower head nozzle in a liquid solution is an effective way of dissolving built up minerals and returning the shower head to full performance. Currently, to soak a shower head, it must either be removed to soak in a tub or a plastic bag is filled with a solution and attached around the shower.

Current methods for soaking shower heads are tedious and can be difficult to perform. It is an object of the present invention to provide a solution to the above-mentioned and other problems of the prior art. Other objects and advantages of the invention will become apparent as the description proceeds.

### BRIEF SUMMARY OF THE INVENTION

The invention disclosed herein is a device comprised of a container with hanger allowing the container to be suspended from a shower head and arm. The interior of the container envelopes some or all of the shower head and shower head nozzles, and provides a means for filling with liquid cleaner in order for the cleaner to remain in contact with the shower head nozzles to facilitate deep cleaning of the nozzles and shower head without having to first remove the shower head.

### BRIEF DESCRIPTION OF THE SEVERAL VIEWS OF THE DRAWING

FIG. 1 is an axonometric view of preferred embodiment container installed on shower head and arm.

FIG. 2 is an axonometric view of preferred embodiment container.

FIG. 3 is a top view of preferred embodiment container installed on shower head and arm.

FIG. 4 is a top view of preferred embodiment container.

FIG. 5 is a side view of preferred embodiment container installed on shower head and arm.

FIG. 6 is a side view of preferred embodiment container.

### DETAILED DESCRIPTION OF THE INVENTION

For the purpose of promoting an understanding of the present invention, references are made in the text hereof an embodiment of a container device for use and adaptation with shower head, nozzles and shower arms. Only one embodiment is depicted in the figures. It should nevertheless be understood that no limitations on the scope of the invention are thereby intended. One of ordinary skill in the art will readily appreciate that modifications such as the dimensions, size, and overall shape of the components may be made. Moreover, alternate but functionally similar materials may be used. The inclusion of additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

For the purposes of promoting an understanding of the principles of the invention reference will now be made to the embodiment illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention which would normally occur to one skilled in the art to which the invention relates.

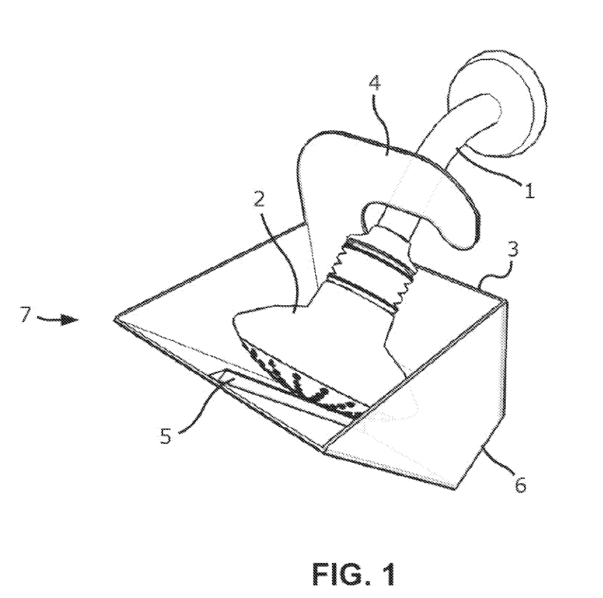

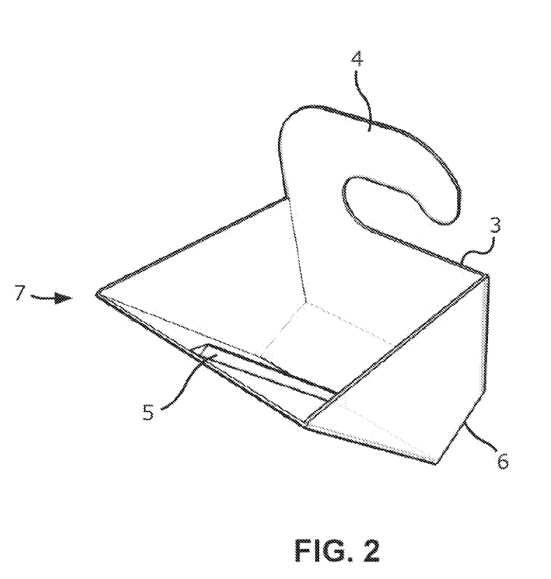

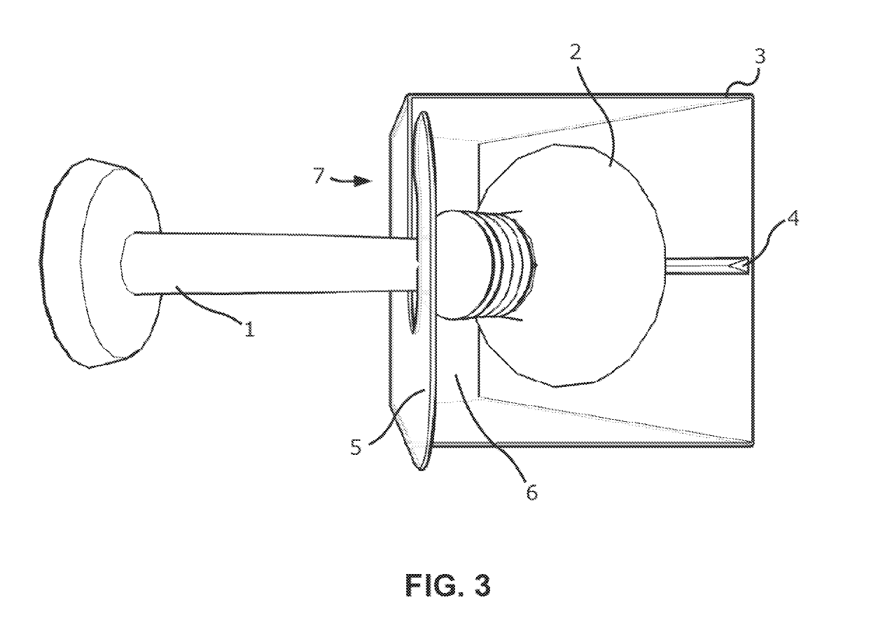

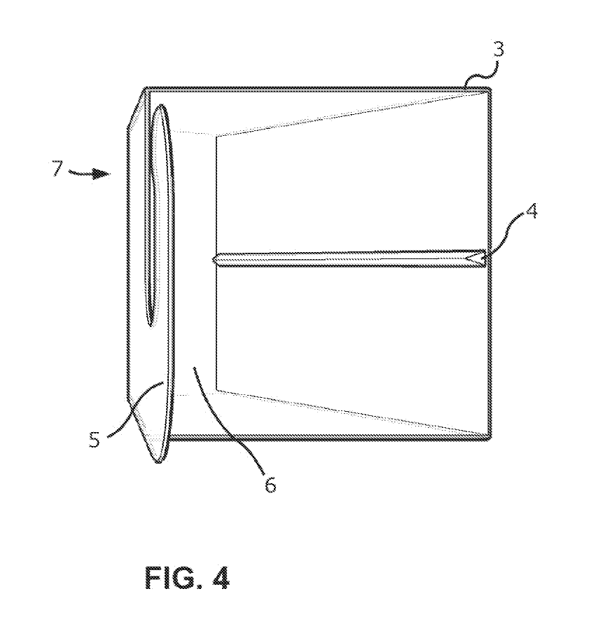

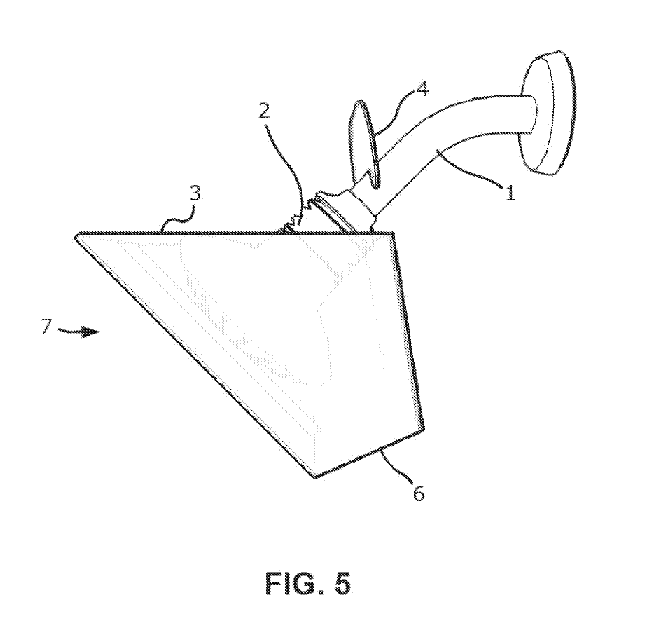

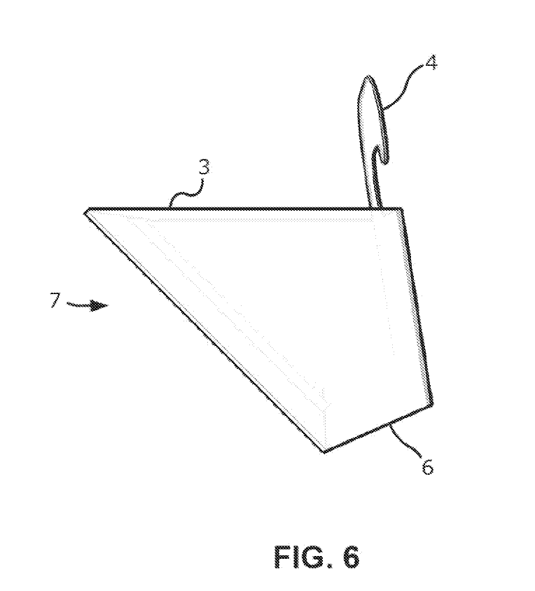

Preferred embodiment is illustrated in FIGS. 1-6. Embodiment container assembly 7 is made from a thin flexible plastic material and includes hanger 4 as the means by which the shower head cleaner application container is suspended from the shower head 2 and standard arm 1. Once the container assembly 7 is installed on a shower head 2 and arm 1, liquid cleaner can be filled by pouring in the top opening of the container until the shower head nozzles are submerged. Spacer 5 maintains a gap between the container inner surface and the shower head nozzles. The container assembly 7 provides a means for liquid cleaner to remain in contact with the shower head 2 to facilitate deep cleaning of the shower head nozzles. Base 6 provides a means for maintaining an upright orientation of the container assembly 7 for hands free filling with liquid cleaner while placed on a level surface.

Other embodiments may have varying size, shape, or material thickness to accommodate a wide range of shower heads which may be commercially available or custom made.

It should be understood that the above-described embodiment of the present invention, particularly, the “preferred” embodiment, is only an example of implementation, merely set forth for a clear understanding of the principles of the invention. Many variations and modifications may be made to the above-described embodiment of the invention as will be evident to those skilled in the art.

The scope of the claims that follow is not limited by the embodiment set forth in the description. The claims should be given the broadest purposive construction consistent with the description as a whole.

1. A container having a body, the body comprising a base portion and walls defining an interior region for receiving and retaining liquid, the body having opposed rear, front and side walls, the walls having an upper edge defining an opening to the interior region, the container's interior geometry and volume accepts a shower head to rest fully or partially within the container, the base is flat so as to rest on a level flat surfaces, base geometry with container walls such that the container's center of mass is in the center of the base when the container is filled with fluid such as water, the front wall with an inner protrusion comprising a “V” shaped or triangular extruded spacer, the rear wall with a hanger comprising: (a) an asymmetric extension above the container opening; (b) a cantilevered segment extending past the center line of the container while maintaining a slotted opening below; and (c) a node extending a distance down toward the rear wall but leaving an opening to accommodate a shower arm, the hanger node allows the passage of the shower arm to pass to the horizontal slot below the cantilevered portion of the hanger, the container assembly supported by contact of the shower arm and head, material rigidity of all components such the container will maintain its general shape while filled with liquid and suspended from the shower head and arm.

2. The body of claim 1, wherein the body comprising a base portion and walls defining an interior region for receiving and retaining liquid, the body having opposed rear, front and side walls, the walls having an upper edge defining an opening to the interior region, the container's interior geometry and volume accepts a shower head to rest fully or partially within the container.

3. The base of claim 1, wherein the base is flat so as to rest on a level flat surfaces, base geometry with container walls such that the container's center of mass is in the center of the base when the container is filled with fluid such as water.

4. The spacer of claim 1, wherein the front wall with an inner protrusion comprising a “V” shaped or triangular extruded spacer.

5. The hanger of claim 1, wherein a hanger comprising: (a) an asymmetric extension above the container opening; (b) a cantilevered segment extending past the center line of the container while maintaining a slotted opening below; and (c) a node extending a distance down toward the rear wall but leaving an opening to accommodate a shower arm.
